(19) United States
(12) Patent Application Publication
(10) Pub. No.: US 2016/0325829 A1
(43) Pub. Date: Nov. 10, 2016

(54) MULTIROTOR TYPE UNMANNED AERIAL VEHICLE AVAILABLE FOR ADJUSTING DIRECTION OF THRUST

(71) Applicant: GWANGJU INSTITUTE OF SCIENCE AND TECHNOLOGY, Gwangju (KR)

(72) Inventors: Hyo Sung AHN, Gwangju (KR); Young Cheol CHOI, Gwangju (KR); Sung Mo KANG, Gwangju (KR); Ji Hwan SON, Gwangju (KR); Byung Hun LEE, Gwangju (KR); Gwi Han KO, Gwangju (KR)

(21) Appl. No.: 15/148,445

(22) Filed: May 6, 2016

(30) Foreign Application Priority Data
May 8, 2015 (KR) 10-2015-0064491

(51) Int. Cl. B64C 27/52; B64C 39/02; B64C 27/08

(52) U.S. Cl. CPC B64C 27/52; B64C 27/08; B64C 39/024; B64C 2201/042; B64C 2201/108

(57) ABSTRACT

The multi-rotor type unmanned aerial vehicle includes: a main body including the battery module and the control module; a plurality of frames connected to a side surface of the main body and extending therefrom; a first motor connected to a distal end of each of the frames; and a drive unit connected to the first motor, wherein the drive unit includes a rotary frame and a stationary frame each having a circular shape and connected to each other in the form of a gyroscope, a second motor supported at the center of the rotatable frame, and a propeller connected to the second motor, and a vector of thrust generated by rotation of the propeller is variable according to rotation of the first and second motors.

### CROSS REFERENCE TO RELATED APPLICATION

This application claims the benefit of Korean Patent Application No. 10-2015-0064491, filed on May 8, 2015, entitled “MULTIROTOR TYPE UNMANNED AERIAL VEHICLE AVAILABLE FOR ADJUSTING DIRECTION OF THRUST”, which is hereby incorporated by reference in its entirety into this application.

### BACKGROUND

1. Technical Field

The present invention relates to a means for controlling motion of an unmanned aerial vehicle such as a quadcopter. More particularly, the present invention relates to an unmanned aerial vehicle provided with a drive unit capable of controlling a vector of thrust generated by propellers of the vehicle.

2. Description of the Related Art

Recently, there is increasing need for unmanned aerial vehicles capable of operating in harsh environments dangerous to humans. Such an unmanned aerial vehicle can obtain aerial images of a difficult-to-access disaster/devastated area, inspect power lines, provide hidden information of an enemy in a battlefield situation, and carry out a reconnaissance mission or a surveillance mission.

Representative examples of an unmanned remotely controlled vertical takeoff and landing aerial vehicle include a single rotor-type helicopter, a coaxial counter rotating helicopter, and a quadcopter. Particularly, a quadcopter can fly in a relatively stable manner using various sensors and signal processing and through control of motors connected to 4 rotors.

FIG. 1 is a schematic view of a typical quadcopter. Referring to FIG. 1, the quadcopter has a structure in which 4 propellers 5 provided to frames extending from a main body 2 are connected to respective BLDC motors 4. The quadcopter can fly using thrust generated by the propellers 5 through rotation of the motors 4 and change flight direction using difference in rotational speed between the motors during flight.

However, the quadcopter has a structure causing the entire fuselage to be tilted in the moving direction during turning maneuvers, is likely to turn over due to wind blowing in the same direction as the moving direction, and has difficulty in stably flying due to vulnerability to disturbances such as wind during stationary flight such as hovering.

Further, when the entire fuselage of the quadcopter fuselage is tilted during turning maneuvers, an increased sectional area thereof encounters air resistance causing increased aerodynamic energy loss.

### BRIEF SUMMARY

The present invention has been conceived to solve such a problem in the art and it is an aspect of the present invention to provide an unmanned aerial vehicle, wherein a motor connected to a propeller is variable in position and thrust can be generated in various directions through control of the position of the motor, thereby allowing the vehicle to fly in a stable manner.

Embodiments of the present invention provide a multi-rotor type unmanned aerial vehicle that is equipped with a battery module and flies according to instructions of a control module controlling rotation of a plurality of propellers. The unmanned aerial vehicle includes: a main body including the battery module and the control module; a plurality of frames connected to a side surface of the main body and extending therefrom; a first motor connected to a distal end of each of the frames; and a drive unit connected to the first motor, wherein the drive unit includes a rotary frame and a stationary frame each having a circular shape and connected to each other in the form of a gyroscope, a second motor supported at the center of the rotatable frame, and a propeller connected to the second motor, and a vector of thrust generated by rotation of the propeller is variable according to rotation of the first and second motors.

The first motor may be connected to one end of each of the frames and may have a rotation axis corresponding to a direction in which the frame extends.

The multi-rotor type unmanned aerial vehicle may further include a support frame passing through the center of the rotary frame and extending diametrically of the rotatable frame, and the support frame may be provide at one end thereof with a second motor and the second motor may have a rotation axis corresponding to a direction in which the support frame extends.

The multi-rotor type unmanned aerial vehicle may further include: a main motor connected to the center of the support frame; and a propeller connected to the main motor, wherein rotation of the second motor causes rotation of the main motor and rotation of the propeller connected to the main motor so as to change a position at which thrust is generated.

The rotation axis of the first motor may lie at right angles to the rotation axis of the second motor; a position at which thrust is generated by the propeller may be variable according to rotation of the first and second motors; and the control module provided to the main body may control the first motor and the second motor provided to each of the frames so as to differently set positions at which thrust is generated by the propellers.

According to embodiments of the present invention, it is possible to provide an unmanned aerial vehicle such as a quadcopter in which a motor generating thrust is variable in position to allow a propeller connected to the motor to be rotated in all directions in a three-dimensional space, thereby allowing the vehicle to fly in a stable manner even when turbulence is encountered and minimizing influence of a disturbance on the vehicle even during stationary flight such as hovering.

### BRIEF DESCRIPTION OF THE DRAWINGS

The above and other aspects, features, and advantages of the present invention will become apparent from the detailed description of the following embodiments in conjunction with the accompanying drawings, in which;

FIG. 1 is a schematic view of a typical quadcopter;

FIG. 2 is a view of a drive unit of a quadcopter according to a first embodiment of the present invention;

FIG. 3 is a view of a drive unit of a multi-rotor type unmanned aerial vehicle according to a second embodiment of the present invention; and

FIGS. 4 to 6 are views illustrating flight of a typical quadcopter and the multi-rotor type unmanned aerial vehicles according to the embodiments of the present invention.

### DETAILED DESCRIPTION

Hereinafter, embodiments of the present invention will be described in detail with reference to the accompanying drawings. However, it should be understood that the present invention is not limited to the following embodiments. In addition, descriptions of details apparent to those skilled in the art will be omitted for clarity.

Embodiments of the present invention provide an unmanned aerial vehicle, for example, an aerial vehicle that is lifted by thrust generated in a vertical direction, such as a quadcopter, and, more particularly to a drive unit capable of changing the position of a motor and propeller, from which a quadcopter gains thrust, in various directions. Features other than the drive unit may employ techniques known in the art. A main body of the unmanned aerial vehicle according to the embodiments may be equipped with a battery module and a control module. The control module may control operation of the drive unit of the unmanned aerial vehicle according to signals remotely transmitted by a user and control the position and rotational speed of each propeller, thereby adjusting flight conditions of a fuselage.

Although a quadcopter, which is a rotorcraft with 4 propellers, is mainly described herein, it should be understood that the present invention may be applied to a driving means of any multi-rotor type unmanned aerial vehicle regardless of the number of propellers, and a drive unit for a quadcopter according to embodiments of the invention may be used along with a typical drive unit for a quadcopter.

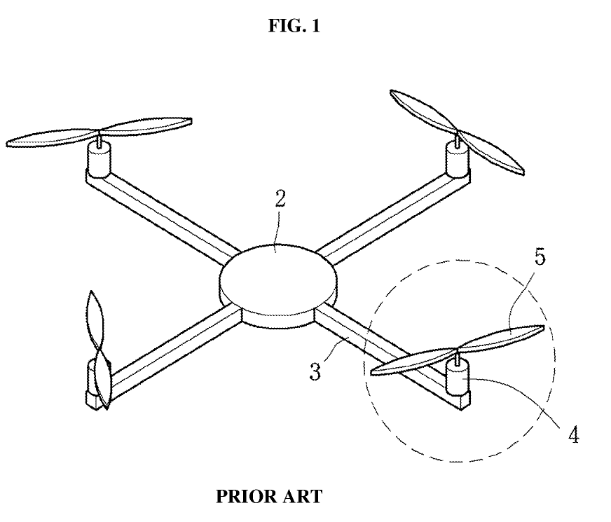

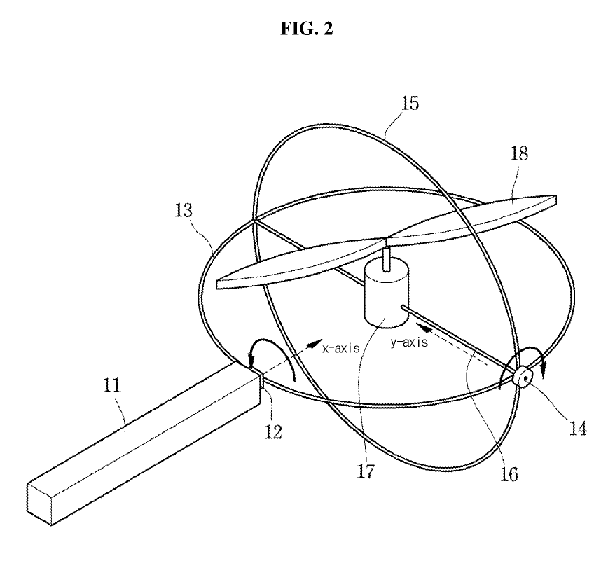

FIG. 2 is a view of a drive unit of a quadcopter according to a first embodiment of the invention, wherein a portion of FIG. 1 designated by a dotted line at one end of a frame 3 extending from a main body 2, corresponding to the center of the quadcopter, that is, a drive unit generating thrust, is enlarged. Since features other than the drive unit can employ techniques known in the art, detailed description thereof will be omitted.

Referring to FIG. 2, a first motor 12 is connected to a distal end of a frame 11 extending from the main body corresponding to the center of the quadcopter. Here, a lower surface of the first motor 12 is connected to the distal end of the frame 11 such that the rotation axis of the first motor 12 lies in a direction in which the frame 11 extends.

The first motor 12 is connected at the center thereof to a rotary frame 13. The rotary frame 13 has a circular shape and is connected at one point to an upper surface of the first motor 12 such that the rotary frame 13 connected to the first motor 12 is rotated about the rotation axis of the first motor 12 upon rotation of the first motor 12.

A support frame 16 may be provided to the rotary frame 13 so as to pass through the center of the rotary frame 13 in a direction perpendicular to the rotation axis of the rotary frame 13. The support frame 16 may be provided at a portion thereof corresponding to the center of the rotary frame 13 with a second motor 17 and a propeller 18 that constitute a drive unit providing thrust to the quadcopter.

The second motor 17 is set to rotate at a predetermined RPM and rotates the propeller 18, thereby providing a certain level of thrust to the quadcopter. Since the rotary frame 13 is fabricated in the form of a guide encircling the propeller, it is desirable that the diameter of the propeller be smaller than that of the rotary frame 13.

Assuming that the direction of the rotation axis of the first motor 12 is the x-axis, the second motor 17 and the propeller 18 are rotatable with respect to the x-axis according to rotation of the first motor 12 such that the vector of thrust can be changed in an upward, downward, or lateral direction with respect to the x-axis.

Further, the support frame 16 is connected at both ends thereof to the rotary frame 13 and is supported by the rotary frame 13, and the third motor 14 may be provided at any one of connection points between the support frame and the rotary frame. The second motor 14 may be coupled thereto such that the rotation axis of the second motor 14 corresponds to a direction in which the support frame 16 extends.

The support frame 16 may be provided at both ends thereof with a stationary frame 15 which has the same shape as the rotary frame 13 and has a plane lying at right angles to the rotary frame. The stationary frame 15 is concentric with the rotary frame 13 and may be securely connected to the rotary frame 13 after being rotated by 90 degrees with respect to the support frame. In other words, in the first embodiment, the rotary frame 13 and the stationary frame 15 are concentric circular frames connected in the form of a gyroscope.

In addition, since the propeller is rotated inside the stationary frame 15, it is desirable that the diameter of the stationary frame 15 be greater than the length of the propeller 18.

The rotary frame 13 contacts the stationary frame 15 at both ends of the support frame 16, and the third motor 14 is placed at the contact point between the rotary frame and the stationary frame. Since the third motor 14 is connected to the support frame 16, rotation of the second motor causes rotation of the support frame. In other words, rotation of the second motor causes rotation of the second motor 17 and the propeller 18, which are provided on the support frame 16.

Here, since the rotation axis of the second motor 14 connected to the support frame 16 lies at right angles to the rotation axis of the first motor 12, assuming that that the rotation axis of the first motor is the x-axis direction, the support frame is rotated about the y-axis perpendicular to the x-axis.

In other words, since the propeller 18 is variable in position inside the rotary frame and the stationary frame according to rotation of the first motor to change the vector of thrust with respect to the x-axis and the y-axis, the vector of thrust can be set in any desired direction in a three-dimensional space.

The quadcopter as set forth above can change the direction of the propeller and thus change the vector of thrust through rotation of the first and second motors during turning maneuvers, thereby minimizing changes in tilt of the fuselage. Thus, the quadcopter can reduce a sectional area generating air resistance and thus energy required for flight as compared with existing quadcopters, thereby increasing flight time, which is relatively short in a typical quadcopter due to limited battery power.

In addition, in flight and operation of a quadcopter, it is necessary to secure stability. If propellers are exposed without any separate protective structure, there is the possibility of damage to humans by rotating propellers during landing due to unskilled manipulation or the like. According to the first embodiment, the rotary frame provided for changing the direction of the propeller and the stationary frame connected thereto can serve as an external guide while moving the propeller.

A typical quadcopter has an increased risk of turning over and becomes unstable to make flight impossible when the fuselage thereof is tilted over a certain angle. The angle at which the fuselage is tilted is proportional to the maximum moving speed of a quadcopter, and stability of the quadcopter sharply decreases with increasing speed of the quadcopter. Generally, in a typical quadcopter, a threshold value of the tilt angle of the fuselage is set to about 45 degrees, and, when the tilt angle reaches the threshold value, the moving speed of the quadcopter is adjusted to reduce the risk that the quadcopter will turn over.

In the quadcopter according to the first embodiment, when the tilt angle of the fuselage increases, it is possible to adjust the tilt of the fuselage by regulating the vector of thrust of a propeller located in a direction in which the fuselage is tilted. In addition, since the directions of thrust of propellers can be individually controlled, it is possible to actively cope with changes in flight speed of the fuselage and to allow the quadcopter to stably fly in various manners.

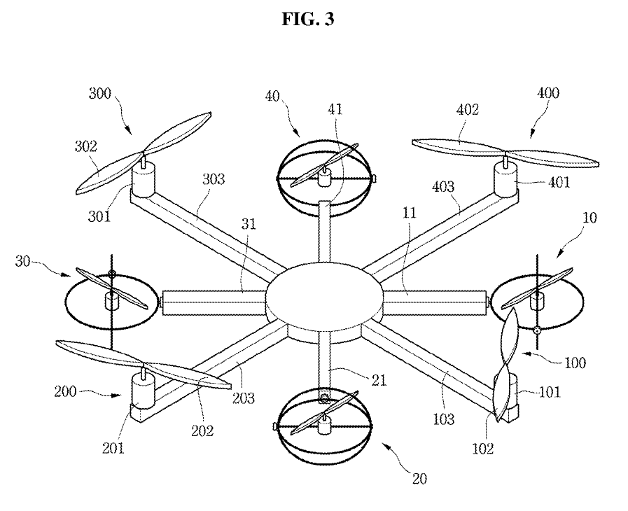

FIG. 3 is a view of a drive unit of a multi-rotor type unmanned aerial vehicle according to a second embodiment of the present invention. The second embodiment provides a multi-rotor type unmanned aerial vehicle in which a drive unit providing a variable thrust vector as described in the first embodiment is combined with a typical drive unit providing a fixed thrust vector. Although the drive unit providing a variable thrust vector is a main drive unit in the first embodiment, a drive unit providing a variable thrust vector in the second embodiment serves as an auxiliary drive unit. Referring to FIG. 3, a plurality of main frames 103, 203, 303, 403 extending from a central main body are provided at ends thereof with main rotors 100, 200, 300, 400, respectively. Although a quadcopter having 4 frames and 4 main rotors will be described in the second embodiment, it should be understood that the number of the rotors is not limited thereto.

The main rotors 100, 200, 300, 400 are composed of motors 101, 201, 301, 401 and propellers 102, 202, 302, 402, respectively, wherein the respective motors and propellers are connected to the main rotors in constant directions to generate thrust in the constant directions.

Auxiliary frames 11, 21, 31, 41 extending from the main body are disposed between the main frames provided with the respective main rotors, and the auxiliary frames may be provided at ends thereof with auxiliary rotors 10, 20, 30, 40, which may be configured in the same manner as the rotor described in the first embodiment.

That is, in the second embodiment, the auxiliary rotors providing a variable thrust vector are provided in addition to the main rotors generating thrust in a constant direction, thereby easily changing a thrust vector through rotation of the motor provided to the auxiliary rotor during turning maneuvers of the unmanned aerial vehicle while providing auxiliary thrust during ascent of the unmanned aerial vehicle.

Although the present invention has been described using an example in which the multirotor takes the form of an octocopter having 8 propellers in FIG. 3, it should be understood that the present invention may be applied to any multi-rotor type unmanned aerial vehicle since the number of auxiliary rotors may vary depending on the number of main rotors.

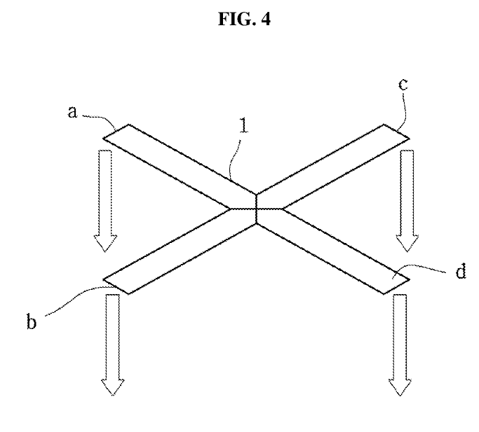

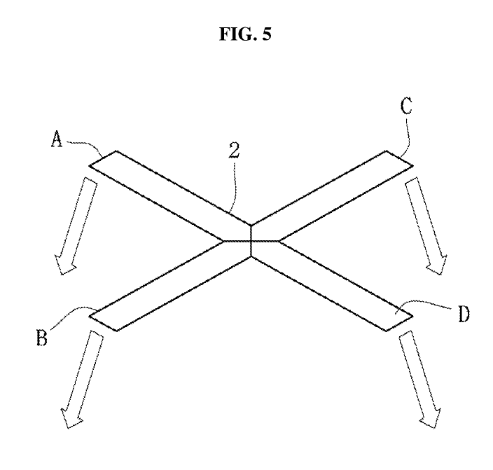

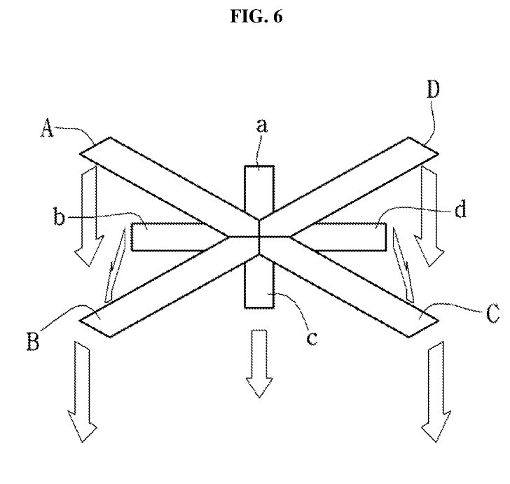

FIG. 4 is a view illustrating flight of a typical multi-rotor type unmanned aerial vehicle and the multi-rotor type unmanned aerial vehicles according to the embodiments of the invention, wherein FIG. 4 shows the case that a quadcopter has a fixed thrust vector perpendicular to the ground as in the related art, FIG. 5 shows the case that a thrust vector of a main rotor is set in a variable manner as in the first embodiment, and FIG. 6 shows the case that a thrust vector of an auxiliary rotor is set in a variable manner as in the second embodiment.

Referring to FIG. 4, a typical quadcopter 1 has a problem in that, since respective propellers a, b, c, d provided to frames extending in four directions generate thrust only in a direction perpendicular to the ground or a fuselage of the quadcopter causing the fuselage to be tilted when a disturbance such as wind is encountered during flight as well as causing the thrust vector to be tilted in a certain direction, flight speed must be reduced in order to ensure stability of the fuselage.

Conversely, a quadcopter 2 using the drive unit according to the embodiments of the invention as described in FIG. 5 can variably adjust the direction of propellers A, B, C, D provided to frames extending in four directions. FIG. 5 illustrates the case that a thrust vector is adjusted for each propeller to ensure stability of the fuselage when a disturbance occurs during hovering. Assuming that the position of the propeller shown in FIG. 2 is an initial position, the position of the propeller shown in FIG. 5 was changed by a predetermined angle by rotating the second motor 14. Here, the vector of thrust applied to the fuselage is changed towards the center of the fuselage by each of the propellers, such that the quadcopter can stably perform stationary flight such as hovering even when a disturbance such as wind is encountered.

Referring to FIG. 6, 4 main frames extending from a main body are provided with main rotors A, B, C, D, respectively, and auxiliary frames formed between the main frames are provided with auxiliary rotors a, b, c, d. The main rotors are configured to provide a constant thrust vector, and the auxiliary rotors are configured to provide a variable thrust vector. In the case of FIG. 6, by changing the directions of propellers provided to the auxiliary rotors, turning maneuvers of the multirotor can be performed and tilt of the fuselage during turning maneuvers can be corrected. In addition, turning maneuvers can be performed only by the auxiliary rotors without changing the rotational speed of the main rotors, and, when a disturbance occurs, the auxiliary rotors can be redirected towards the disturbance, thereby further improving stability of the fuselage.

As described above, the present invention provides a quadcopter in which a motor providing thrust to the quadcopter is variable in position and thus can rotate propellers connected thereto in any direction, thereby allowing the quadcopter to fly in a stable manner even when turbulence is encountered while minimizing influence of a disturbance even during stationary flight such as hovering.

Although the present invention has been described with reference to some embodiments, it should be understood that the foregoing embodiments are provided for illustration and are not to be construed in any way as limiting the present invention, and that various modifications, changes, alterations, and equivalent embodiments can be made by those skilled in the art without departing from the spirit and scope of the invention.

For example, each component described in the embodiments of the present invention can be modified in various forms. In addition, differences relating to these modifications and applications are to be construed as within the scope of the invention defined in the appended claims.

What is claimed is:

1. A multi-rotor type unmanned aerial vehicle that is equipped with a battery module and flies according to instructions of a control module controlling rotation of a plurality of propellers, the unmanned aerial vehicle comprising:
a main body comprising the battery module and the control module;
a plurality of frames connected to a side surface of the main body and extending therefrom;
a first motor connected to a distal end of each of the frames; and
a drive unit connected to the first motor,
wherein the drive unit comprises a rotary frame and a stationary frame each having a circular shape and connected to each other in the form of a gyroscope, a second motor supported at a center of the rotatable frame, and a propeller connected to the second motor, and
a vector of thrust generated by rotation of the propeller is variable according to rotation of the first and second motors.

2. The multi-rotor type unmanned aerial vehicle according to claim 1, wherein the first motor has a rotation axis corresponding to a direction in which the frame extends.

3. The multi-rotor type unmanned aerial vehicle according to claim 1, further comprising:
a support frame passing through the center of the rotary frame and extending diametrically of the rotatable frame.

4. The multi-rotor type unmanned aerial vehicle according to claim 3, wherein the support frame is provided at one end thereof with a third motor, the third motor having a rotation axis corresponding to a direction in which the support frame extends.

5. The multi-rotor type unmanned aerial vehicle according to claim 4, further comprising:
a main motor connected to a center of the support frame; and
a propeller connected to the main motor.

6. The multi-rotor type unmanned aerial vehicle according to claim 5, wherein rotation of the third motor causes rotation of the main motor and rotation of the propeller connected to the main motor so as to change a position at which thrust is generated.

7. The multi-rotor type unmanned aerial vehicle according to claim 4, wherein a rotation axis of the first motor lies at right angles to the rotation axis of the third motor, and a position at which thrust is generated by the propeller is variable according to rotation of the first and third motors.

8. The multi-rotor type unmanned aerial vehicle according to claim 1, wherein the control module provided to the main body controls the first motor provided to each of the frames and the second motor so as to differently set positions at which thrust is generated by the propellers.

9. The multi-rotor type unmanned aerial vehicle according to claim 1, wherein a diameter of each of the rotary frame and the stationary frame is greater than a length of the propeller such that the rotary frame and the stationary frame serve as a guide for the propeller.

10. A multi-rotor type unmanned aerial vehicle that is equipped with a battery module and flies according to instructions of a control module controlling rotation of a plurality of propellers, the unmanned aerial vehicle comprising:
a main body comprising the battery module and the control module;
a plurality of main frames connected to a side surface of the main body and extending therefrom;
a main rotor disposed at a distal end of each of the main frames;
auxiliary frames extending between the main frames; and
an auxiliary rotor disposed at a distal end of each of the auxiliary frames,
wherein the auxiliary rotor comprises: a rotary frame and a stationary frame each having a circular shape and connected to each other in the form of a gyroscope; and a main motor and a propeller disposed at a center of the rotatable frame, and
the main rotor is coupled to generate thrust in a constant direction and the auxiliary rotor is coupled to allow a vector of thrust to be variable according to rotation of the rotatable frame.

11. The multi-rotor type unmanned aerial vehicle according to claim 10, wherein each of the auxiliary frames is connected at one end thereof to a first motor, the first motor having a rotation axis corresponding to a direction in which the auxiliary frame extends.

12. The multi-rotor type unmanned aerial vehicle according to claim 11, wherein the first motor is connected to a rotary frame and a stationary frame each having a circular shape,
the unmanned aerial vehicle further comprising:
a support frame passing through a center of the rotary frame and extending in a direction at right angles to the rotation axis of the first motor.

13. The multi-rotor type unmanned aerial vehicle according to claim 12, wherein the support frame is provided at a center thereof with a second motor and a propeller, and a rotation axis of the second motor lies at right angles to the rotation axis of the first motor.
